(19) United States
(12) Patent Application Publication
(10) Pub. No.: US 2007/0195406 A1
(43) Pub. Date: Aug. 23, 2007

(54) Screens, microstructure templates, and methods of forming the same

(76) Inventor: Robert L. Wood, Apex, NC (US)

Correspondence Address: MYERS BIGEL SIBLEY & SAJOVEC, PO BOX 37428, RALEIGH, NC, 27627, US

(21) Appl. No.: 11/580,480

(22) Filed: Oct. 13, 2006

Related U.S. Application Data
(60) Provisional application No. 60/775,613, filed on Feb. 22, 2006.

(51) Int. Cl. G03B 21/60

(52) U.S. Cl. 359/459

(57) ABSTRACT

A front projection screen can include a microstructure on an upper surface of a substrate. The microstructure can include a surface that is inclined relative to the upper surface the substrate. A conformal reflective layer that conforms to the surface of the microstructure, can include discrete reflective microscopic objects that are substantially aligned to respective opposing portions of the inclined surface of the microstructure.

### CROSS-REFERENCE TO RELATED APPLICATION

This application claims priority to U.S. Provisional Patent Application No. 60/775,613, filed: Feb. 22, 2006, entitled “Microstructure Templates and Guided-Assembly Methods and Devices,” the entire content of which is incorporated herein by reference.

### FIELD OF THE INVENTION

The present invention relates to microstructures and methods of forming the same.

### BACKGROUND

Microlens arrays are used in applications where gathering light from a source and then directing it to various locations and in various angles is desirable. Such applications include computer displays, screens for projection televisions, and certain illumination devices. The utility of the array can often be enhanced by inclusion of an aperture mask which only permits light to pass through the array in certain directions and which absorbs ambient light which would otherwise reflect off of the surface of the array and degrade the effective contrast of the optical system. Such arrays and masks with apertures may be conventionally formed at the points at which the lenses focus paraxial radiation.

Conventional techniques for creating microlens arrays with aperture masks may involve fabrication of the arrays on suitable substrates which are or can be coated with appropriate radiation absorbing mask materials. High intensity radiation is then directed through the lenses and focused by them. If the structure of the lens array, substrate and mask has been designed so that the focal points of the lens array are at or near the mask layer, the radiation will form apertures in the mask at these focal points. See, for example, U.S. Pat. No. 4,172,219 to Deml et al., entitled Daylight Projection Screen and Method and Apparatus for Making the Same and U.S. Pat. No. 6,967,779 to Fadel et al., entitled Micro-Lens Array With Precisely Aligned Apertures Mask and Methods of Producing Same.

It is also known to deposit pigments suspended in a liquid onto a substrate as shown in FIGS. 1A-1C. In particular, a liquid 125 including pigment particles 120 can be deposited on a substrate 105 as shown in FIG. 1A. The liquid 125 can be dried (FIGS. 1B and 1C) to provide a dried coating 130 including the pigment particles 120 aligned with an upper surface 107 of the substrate 105.

### SUMMARY

Embodiments according to the invention can provide screens, microstructure templates, and methods of forming the same. Pursuant to these embodiments, a front projection screen can include a microstructure on an upper surface of a substrate. The microstructure can include a surface that is inclined relative to the upper surface the substrate. A conformal reflective layer that conforms to the surface of the microstructure, can include discrete reflective microscopic objects, a respective one of which is substantially aligned to a respective opposing portion of the inclined surface of the microstructure.

In some embodiments according to the invention, a method of forming a front projection screen can include forming a conformal reflective layer on an inclined surface of a microstructure, including discrete reflective microscopic object, a respective one of which is substantially self-aligned to an opposing portion of the inclined surface of the microstructure.

In some embodiments according to the invention, a method of forming a front projection screen includes forming a plurality of lenticular concave microstructures having asperical shapes with openings of about 80 microns and depths of about 40 microns. A liquid mixture is applied to the plurality of lenticular concave microstructures. The aluminum flake pigment has an average particle size of about 14 microns. The plurality of lenticular concave microstructures having the liquid applied thereto are heated at a temperature of about 200° F.

In some embodiments according to the invention, a method of forming a front projection screen includes forming a plurality of lenticular concave microstructures having asperical shapes with openings of about 80 microns and depths of about 40 microns, separated from one another by 5 micron wide planar ridges. A liquid is applied to the plurality of lenticular concave microstructures, where the liquid mixture includes metalized flake pigment. The plurality of lenticular concave microstructures having the liquid applied thereto is cured at about 60 to about 75° F. for about five hours.

In some embodiments according to the invention, a method of forming a front projection screen includes forming a plurality of lenticular concave microstructures having asperical shapes with openings of about 80 microns and depths of about 40 microns. A liquid is applied to the plurality of lenticular concave microstructures, where the liquid mixture includes metalized flake pigment. The plurality of lenticular concave microstructures having the liquid applied thereto is cured at about 60 to about 75° F. for about one hour and then heating to about 120° F. for about 10 minutes.

### BRIEF DESCRIPTION OF THE FIGURES

FIGS. 1A-1C are cross-sectional views that illustrate orientations of flake-type pigment particles during drying on a planar surface according to the prior art.

FIGS. 2A-2C are cross-sectional views that illustrate methods of forming front projection screens including concave microstructures with inclined surfaces having conformal reflective layers thereon according to some embodiments of the invention.

FIG. 3 is a perspective view that illustrates convex microreflectors tilted toward a projection source for redirection of light toward a viewer in some embodiments according to the invention.

FIG. 4 is a perspective view that illustrates a microreflector outer surface configured to provide horizontal and vertical divergence of reflected light in some embodiments according to the invention.

FIG. 5 is cross-sectional view that illustrates semi-diffuse reflectance produced by reflective flake-type pigments in some embodiments according to the invention.

FIG. 6A-6C are cross sectional views that illustrate methods of forming front projection screens including convex microstructures with inclined surfaces with conformal reflective layers thereon according to some embodiments of the invention.

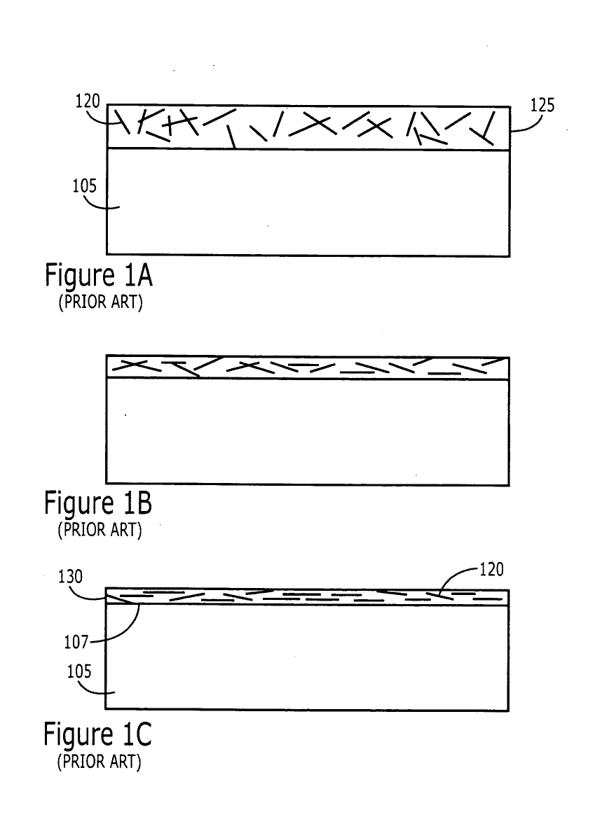

### DESCRIPTION OF EMBODIMENTS ACCORDING TO THE INVENTION

The invention is described hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout. As used herein the term “and/or” includes any and all combinations of one or more of the associated listed items and may be abbreviated as “/”.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, regions, steps, operations, elements, and/or components, but do not preclude the presence or addition of one or more other features, regions, steps, operations, elements, components, and/or groups thereof.

It will be understood that when an element such as a layer or region is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will be understood that, although the terms first, second, etc. may be used herein to describe various elements, components, regions, layers and/or sections, these elements, materials, regions, layers and/or sections should not be limited by these terms. These terms are only used to distinguish one element, material, region, layer or section from another element, material, region, layer or section. Thus, a first element, material, region, layer or section discussed below could be termed a second element, material, region, layer or section without departing from the teachings of the present invention.

Furthermore, relative terms, such as “lower”, “base”, or “horizontal”, and “upper”, “top”, or “vertical” may be used herein to describe one element's relationship to another element as illustrated in the Figures. It will be understood that relative terms are intended to encompass different orientations of the device in addition to the orientation depicted in the Figures. For example, if the device in the Figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above-and below. Moreover, the terms “front” and “back” are used herein to describe opposing outward faces of a front projection screen. Conventionally, the viewing face is deemed the front, but the viewing face may also be deemed the back, depending on orientation.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. Moreover, sharp angles that are illustrated, typically, may be rounded. Thus, the regions illustrated in the figures are schematic in nature and their shapes are not intended to illustrate the precise shape of a region and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In some embodiments according to the present invention, pre-formed microstructures (with inclined planar or curved surfaces) can be used as templates for guided assembly of micro devices useful in a range of applications. For example, in some embodiments according to the invention, the production of a three-dimensional microstructure on a substrate surface is followed by application of microscopic objects. In some embodiments according to the invention, the microscopic objects can be discrete components in a liquid mixture where the objects are reflective so as to be suitable for use in, for example, a front projection screen. The microscopic objects can be particles, plates, filaments, fibers, spheres, etc. that can be applied (in the liquid mixture) to the surface of the microstructure. An internal or external stress may be applied to the microscopic objects to cause orientation or alignment of the objects in relation to the microstructures. Examples of such stresses include forces arising from gravity, surface tension, shrinkage, or mechanical shear and/or compression and/or flow. Alternatively, physical adsorption, chemical coupling, or fusing of objects may be used to orient and attach objects to the microstructure surface. In some embodiments according to the present invention, a method to induce alignment and/or attachment includes the use of external magnetic or electrostatic forces, in the case of ferromagnetic objects or dielectric objects, respectively.

One example of a guided assembly device is a reflective surface having controlled reflection properties and useful as a front projection screen for image display applications. In this device, a microstructure is formed which has a corrugated surface topology. The depth of the topology may be on the order of 5-100 μm, with individual corrugations measuring from 10-1000 μm in width. Such microstructures may be produced, as disclosed in, for example, published U.S. Patent Application Nos. 2005/0058947; 2005/0058948; 2005/0058949 and/or 2003/00206342, the disclosures of which are incorporated herein by reference.

After formation of the microstructure, a liquid containing microscopic reflective objects mixed with a transparent organic binder may be applied to the surface and dried. The microscopic reflective objects may be in the form, for example, of conventional aluminum “flake” type of pigment that may be used in the formulation of metallic inks and paints. The size of individual objects may be smaller than the microstructures themselves, and may be in the range of 1-20 μm. On flat substrates, these “flake” style pigments may orient themselves such that they overlap and lay substantially parallel to an opposing surface of the substrate during drying or curing, presenting a significant amount of reflective surface area in the coating surface. In some embodiments according to the invention, these orientation effects apply to irregularly shaped surfaces, and may provide a basis for constructing surfaces whose reflective properties can be controlled by the shape of the underlying surface.

When these “flake” type pigments are applied to microstructures as described above, they can be induced to orient their surface in conformance to the microstructure topology. This orientation may be “locked in” as the transparent organic binder dries and solidifies. The “flake” pigment in this example may be applied in the form of a liquid mixture containing the pigment, a transparent organic binder, and a volatile solvent. This liquid may be applied using conventional techniques, for example, by spraying, brushing, metering rod, doctor blade, flow coating, curtain coating, roller coating, slot-die coating, screen printing, gravure roll coating, and the like.

In some embodiments, the binder is a self-curing type of binder, and the liquid coating is allowed to dry in air at room temperature or at elevated temperature to evaporate solvent. Other embodiments may use a radiation curing binder, and the applied liquid film is exposed to the appropriate radiation source, for example, an ultraviolet (UV) curing source. The binder material may be chosen to provide abrasion and scratch resistance in the composite coating. During the drying/curing stages, shrinkage of the film causes pigment particles to align with the surface of the microstructure such that substantially all of the surface area is covered with an oriented layer of reflective pigment. Moreover, these particles conform to the surface of the microstructure in a predictable manner, allowing the reflective properties of the final device to be determined by the shape of the underlying microstructure in combination with the reflective properties of the pigment.

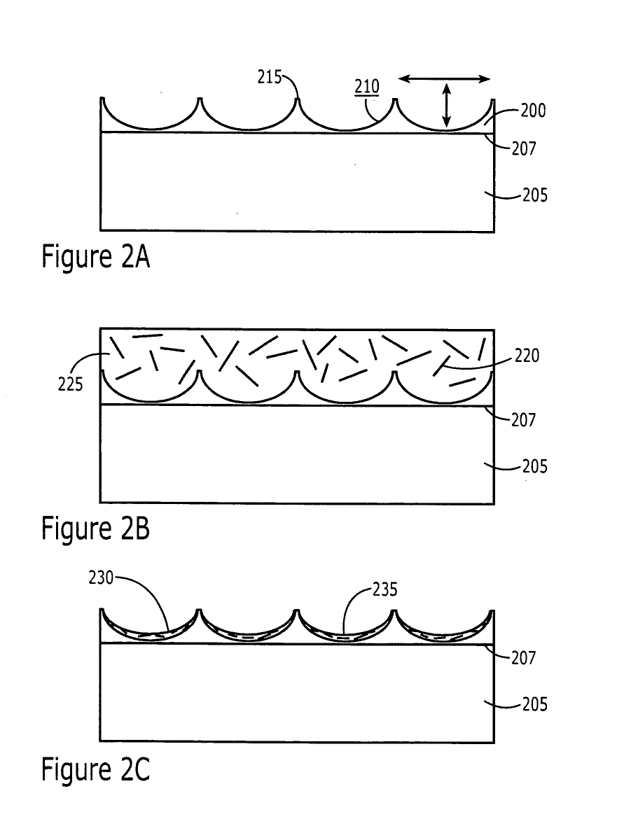

FIGS. 2A-2C are cross sectional views that illustrate forming front-projection screens with microstructures having inclined surfaces as templates in some embodiments of the invention. According to FIG. 2A, a microstructure 200 is provided on an upper surface 207 of a substrate 205. The microstructure 200 is formed to include concave recesses therein. In some embodiments according to the invention, the concave recesses can measure 40 microns deep and 80 microns across at an opening of the recess. As further shown in FIG. 2A, the concave recesses are separated by ridges 215, which, in some embodiments according to the invention, can be approximately 5 microns wide.

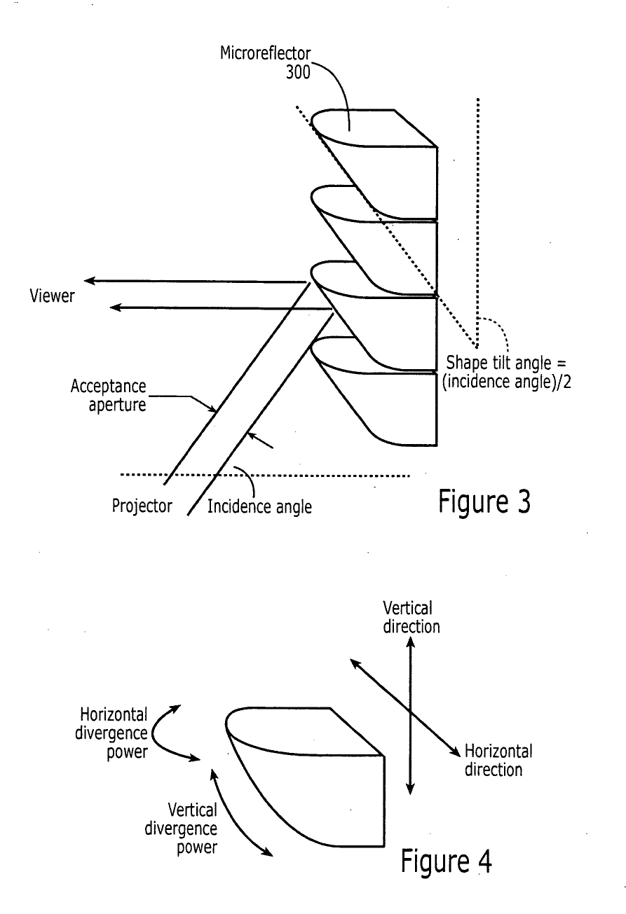

The concave recesses in the microstructure 200 include inclined surfaces relative to the upper surface 207 on the substrate 205. In particular, portions 210 of the concave recesses that extend from a base of the recess toward the ridges 215 are inclined relative to the horizontal orientation of the upper surface 207. It will be understood that although the inclined surface 210 is shown as being curved, the inclined surface may also be planar (i.e., straight) but still be inclined relative to the upper surface 207. It will be further understood that in some embodiments according to the invention, the inclined surface 210 can represent any inclined surface of a microstructure extending in any dimension. In other words, in some embodiments according to the invention, the microstructure 200 may include curved surfaces in one or both dimensions as shown in, for example, FIGS. 3 and 4.

It will be understood that although FIGS. 2A-2C show concave microstructures, the microstructures may have any shape that includes an inclined surface relative to an upper surface on which the microstructures are located. For example, the microstructures can be shaped as prisms (inverted or otherwise), polyhedra, cylinders, aspheres, as well as combinations of these or other shapes. Furthermore, the microstructures can also be formed as convex microstructures as shown, for example, according to FIGS. 4-6.

According to FIG. 2B, a liquid mixture 225 is applied to the microstructure 200. The liquid mixture 225 includes discrete reflective microscopic objects 220 suspended therein. It will be understood that the discrete reflective microscopic objects 220 can be reflective materials, such as reflective pigments or inks, suitable for coating of microstructures to be used in front projection screen applications providing, for example, the performance described herein in reference to Example 1-3. In some embodiments according to the invention, the discrete reflective microscopic objects 220 can be mixed with a powder rather than a liquid.

According to FIG. 2C, the liquid mixture 225 is cured to provide a conformal reflective layer 230 on the microstructure 200, which may be absent from surfaces of the ridges 215. The discrete reflective microscopic objects 220 become substantially aligned to respective opposing portions of the inclined surface 210. For example, in some embodiments according to the invention, the discrete reflective microscopic objects 220 become substantially parallel to the inclined surface 210 over which the conformal reflective layer 230 is applied and cured.

When the objects are described as substantially aligned, it will be understood that the object becomes oriented relative to the underlying inclined surface so that incoming light can be reflected toward a viewer to adequately perform as, for example, a front projection screen. In some embodiments according to the invention, a major dimension of the object is oriented substantially parallel to the inclined surface.

In some embodiments according to the invention, an internal or external stress is applied to the microscopic objects during curing to cause the alignment of the objects in relation to the inclined surface 210. Examples of such stresses include forces arising from gravity, surface tension, shrinkage, or mechanical shear and/or compression and/or flow. Alternatively, physical adsorption, chemical coupling, or fusing of objects may be used to orient and attach objects to the microstructure surface. In some embodiments according to the present invention, a method to induce alignment and/or attachment includes the use of external magnetic or electrostatic forces, in the case of ferromagnetic objects or dielectric objects, respectively.

A front-projection screen produced in accordance with embodiments of the invention can provide desirable viewing properties such as high on-axis gain, wide horizontal viewing angle, narrow vertical viewing angle and high contrast. In addition, screens may be produced that permit placement of the projection source off-axis relative to the viewer, which may be highly desirable for so-called “close coupled” projection sources wherein the projector is placed very close to, and slightly below the bottom of the screen. Such a configuration may be suitable for front projection applications in the consumer large-screen video market due to its compact design and ease of installation and use. Such a screen that may be produced using method embodiments according to the present invention is described herein in greater detail.

An efficient front projection screen should reflect substantially all light arriving from a projection source back toward a well-defined viewing space generally located in front of the screen. Properties of these screens include: projector acceptance angle(s), on-axis gain (brightness directly in front of screen compared to a Lambertian diffuser), horizontal view angle, vertical view angle, and ambient light rejection capabilities. A flat surface covered with individually tunable microscopic reflectors may provide an approach to meeting these requirements. Each microscopic reflector may be designed to efficiently redirect light arriving from the projector and diverge this light into a well-defined viewing space enclosed by prescribed horizontal and vertical view angles. The specific shape of a given micro reflector may be configured differently from each of its neighbors to account for its unique position on the screen relative to a fixed projection source and viewer location. Thus, in some embodiments according to the invention, screens may include an array of microreflectors, each with differing shapes.

In some embodiments according to the invention, a screen includes individual reflective shapes, each of which is smaller than the projected pixel size, and each is configured to reflect light from a projector at a known location into a defined viewing zone. In defining the shape of a given microreflector, it is useful to break its shape down into individual shape elements. The first element is termed the “shape tilt”, and describes the angle that the main plane of the structure makes with the substrate surface, as shown, for example, in FIG. 3. The tilt redirects light arriving from an off-axis projector into the center of the viewing zone. Without shape tilt, most of the reflected light may exit at an angle comparable to the angle of incidence from the projector. This may have the effect of wasting a large portion of projected light by sending it to the floor or ceiling, in the case of a ceiling-mounted or floor-mounted projector, respectively. In some embodiments, the amount of shape tilt may vary across the screen and can be calculated at any particular point on the screen as one-half the angle of incidence from the projector. In some embodiments where the projection incidence angle is opposite and similar to the viewing angle, little or no shape tilt may be needed. In some embodiments, the tilt angle may be a compound angle, i.e. it may have a component measured relative to a horizontal reference line, and a component measured relative to a vertical reference line. A compound tilt angle may redirect light arriving at a radially displaced point on the screen (e.g. near the edge) from an off-axis projector source.

A second microreflector shape element is termed the “horizontal divergence power”, and describes the curvature of the microreflector that provides it the ability to diverge light in the horizontal plane, as shown, for example, by FIG. 4. Horizontal divergence gives the screen the ability to be viewed from angles other than directly in front of the screen, for example, off to one side of the screen. Large horizontal divergence power provides a large horizontal field of view and lower screen gain, while low horizontal divergence power provides a narrower field of view and higher gain. Horizontal divergence power can be produced by a reflective surface having either a concave or convex shape. The shape of this surface may be spherical, aspherical, polyhedryl, planar, or a combination of the four types. Generally a more steeply curved shape may provide greater horizontal divergence power, while a planar shape may cause less divergence.

A third microreflector shape element is termed the “vertical divergence power” and describes the ability of the microreflector to diverge light into the vertical plane, as shown, for example, by FIG. 4. Vertical divergence power shares attributes of horizontal divergence power, but rotated into the vertical plane. Through an appropriate combination of shape tilt, horizontal divergence power, and vertical power, each microreflector may be tuned to provide reflection of the projected light toward a viewer.

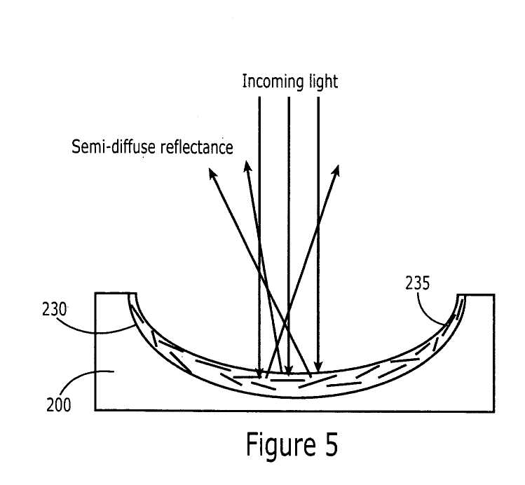

In addition to horizontal and vertical divergence power, the microstructure may have the ability to scatter incident light into a range of angles. This may be provided by texturing of the surface of each microreflector, or by combining an array of microreflectors with a separate transmissive diffusive layer adjacent or attached to the microreflector sheet. In some embodiments, texturing of the individual microreflectors may be provided through selection of the type and size of the reflective pigment particles attached to the microstructure. For example, aluminum flake type pigments may inherently produce some scattering of reflected light rather than a simple mirror-like (specular) reflection, as shown, for example, by FIG. 5. This is due to imperfections in the layering of individual pigment particles, resulting in some particles being tilted more or less than their immediate neighbors. Imperfections in the flatness of each pigment particle may cause the particle to reflect light into a range of angles rather than a single angle. Steps formed by the overlap of adjacent particles may provide a scattering edge. Furthermore, pigment particle size may be selected to include some particles that are close to or smaller than the wavelength of light, which may enhance scattering. Thus, the inherent scattering capabilities of the pigment particles may provide an advantageous diffuse reflectance in a front projection screen. In some embodiments, it may be desirable to rely on the diffuse reflectance-of the pigment particles to provide some or all of the desired divergence in the reflected light. For example, in screens requiring relatively low vertical divergence (most real screens), inherent pigment scattering may provide all the required vertical divergence, which in turn means that the underlying microstructure need not produce any vertical divergence power. This may be beneficial in reducing the complexity of microstructure shape. Semi-diffuse reflection assisted by scattering may provide further benefit in helping to reduce the effects of speckle, sparkle, and moiré artifacts that might otherwise be present in a screen that is purely reflective.

Screens produced according to methods according to the present invention may have improved light rejection qualities over conventional screens. In particular, screens described herein that direct reflected light into a wide horizontal distribution and narrow vertical distribution will naturally reject a large portion of ambient light. impinging on the screen by reflecting it into angles outside the designed viewing zone. Ambient light arriving from angles outside the viewing zone may simply be reflected into non-viewing space (typically above or below the viewer) and therefore may not degrade the quality of the image reflected from the projector. In contrast, the Lambertian design typical of commercially available front projection screens will reflect at least a portion of light toward the viewer, regardless of its origin or direction relative to the projector. Light rejection of screens according to embodiments of this invention may be further enhanced when designed for the “close coupled” screen configuration. In these embodiments, the screen is configured to reflect light toward a viewer when it is incident from a projector that is close to, and below the screen itself. Since most common sources of ambient light do not originate from points below and close to the screen, the close-coupled screen may be designed to more effectively discriminate between ambient light and projected light. Ambient light arriving from points other than close to and below the screen may be reflected into non-viewing areas and therefore do not degrade the quality of the projected image.

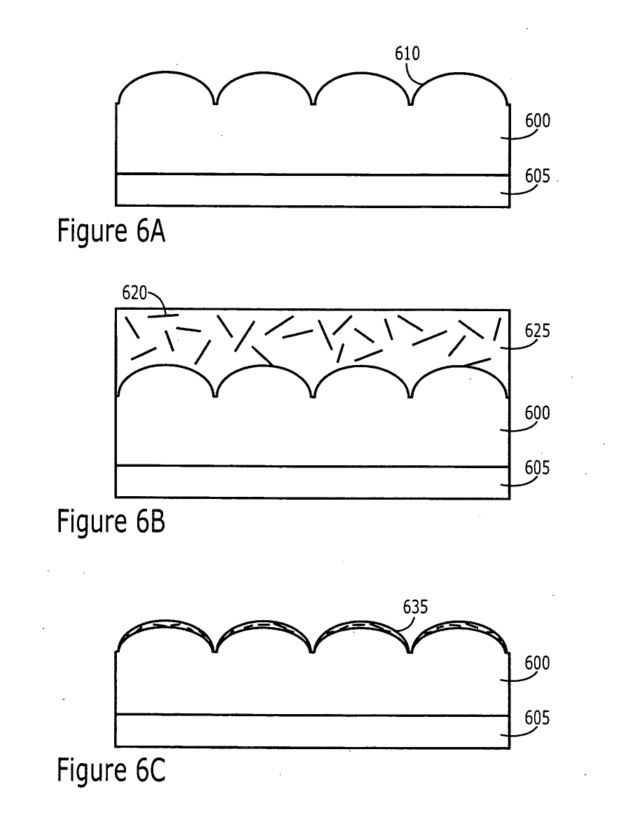

FIG. 6A-6C are cross sectional views that illustrate methods of forming microstructures with inclined surfaces having conformal reflective layers formed thereon according to some embodiments in the invention. In particular, FIG. 6A illustrates a microstructure 600 formed to include convex-shaped microstructures with surfaces 610 inclined relative to an upper surface of a substrate 605. It will be understood that the convex microstructure 600 shown in FIGS. 6A-6C can be used to form the microstructures shown in perspective in FIGS. 3 and 4. It will be further understood that the convex microstructures 600 can have surfaces that are curved in both the vertical and horizontal dimensions as shown in FIG. 4 or can include one surface that is planar (in one of the dimension) and another surface that is curved (in the other dimension). Alternatively, both surfaces, in both dimensions) may be planar.

According to FIG. 6B, in some embodiments according to the invention, a liquid mixture 625 including discrete reflective microscopic objects 620 is applied to the microstructure 600. In some embodiments according to the invention, the liquid mixture 625 is cured to provide a conformal reflective layer 635 so that the discrete reflective microscopic objects 620 are substantially aligned to the incline surface 610 of the convex microstructure 600, as illustrated by FIG. 6C.

In some embodiments according to the invention, an internal or external stress is applied to the microscopic objects during curing to cause the substantial alignment of the objects in relation to the inclined surface 610. Examples of such stresses include forces arising from gravity, surface tension, shrinkage, or mechanical shear and/or compression and/or flow. Alternatively, physical adsorption, chemical coupling, or fusing of objects may be used to orient and attach objects to the microstructure surface. In some embodiments according to the present invention, a method to induce alignment and/or attachment includes the use of external magnetic or electrostatic forces, in the case of ferromagnetic objects or dielectric objects, respectively.

### EXAMPLE 1

This example describes the construction of a front projection screen in accordance with some embodiments of the invention. A microstructure was originated as previously disclosed using shape generation followed by replication on a 7 mil thick polyester sheet. The microstructure of this example consists of a lenticular-like concave shape (similar to that shown in FIG. 2) with a width of about 80 μm and a depth of about 40 μm. The curvature of the lenticular shape was aspherical across the horizontal direction and produced broad horizontal divergence (approximately 70° FWHM) and narrow vertical divergence (approx. 15° FWHM) in transmitted light. Each lenticular element was separated by a narrow ridge of approximately 5 μm in width. This microstructure was replicated from the original master shape using a photopolymer replication process, wherein a liquid photopolymer (Sartomer PRO6500) was flowed between the original master and a blank 7 mil polyester sheet using a laminator, then cured using UV light at approximately 300 W/inch centered around 360 nm in wavelength, followed by separation of the original master.

The microstructure thus produced was coated with a liquid coating mixture consisting of 2 parts by weight of a commercial air-cure polyurethane resin dissolved in a solvent (Zar, United Gilsonite Laboratories), 1 part by weight aluminum flake-type pigment (Type 737, Toyal Americas Inc.) with a mean particle size of 14 μm, and 1 part paint thinner. This coating was applied to the microstructure sheet by applying a puddle of liquid on one edge of the sheet, and drawing this down to a uniform thickness using a wire-wound metering rod wound with 0.008 inch diameter wire. The rod was uniformly drawn in contact across the sheet in a direction parallel to the ridges separating the microstructures. The coated sheet was then baked on a hot plate for one hour at 200° F. to evaporate solvent and accelerate the curing process. The sheet thus coated and baked had a uniform gray matte appearance and was opaque to visible light. Examination under a microscope showed that the concave microstructures were uniformly coated with the reflective pigment, while the thin ridges between microstructures had little or no coating. A microscopic cross-section of the coated microstructure verified that the coating had conformed to the concave shape of the microstructure, with respective pigment flakes lying parallel to the respective opposing microstructure surface, as illustrated in FIGS. 2 and 5.

When configured as a front screen, the sample of Example 1 demonstrated an on-axis gain of 1.8 versus a Lambertian diffuser, a horizontal light divergence of 150° FWHM, a vertical light divergence of 36° FWHM, and total reflectance of 84% compared to a Lambertian reflector. For comparison, a typical Lambertian screen may produce a gain of 1.0, a horizontal divergence of 120° FWHM and a vertical divergence of 120° FWHM. Thus, the screen produced according to this example showed higher on-axis brightness compared to a typical Lambertian screen, yet provided greater horizontal view angle. The screen sample also demonstrated excellent rejection of ambient light from sources vertically displaced from the screen (e.g. overhead lights). When viewed with a projected image, the screen showed excellent contrast and visibility in a brightly lit setting, and very good color saturation and picture detail, indicative of high contrast compared to a Lambertian type screen. In addition, the screen sample showed good resistance to scratching and smudging, and showed no damage after being tightly rolled into a cylindrical shape, such as might be done for screen storage.

### EXAMPLE 2

This example describes the construction of a front projection screen in accordance with some embodiments of the invention. A microstructure was originated as previously disclosed using shape generation followed by replication on a 3 mil thick polyester sheet. The microstructure of this example consists of a lenticular-like concave shape (similar to that shown in FIG. 2) with a width of about 80 μm and a depth of about 40 μm. The curvature of the lenticular shape was aspherical across the horizontal direction and produced broad horizontal divergence (approximately 50° FWHM) and narrow vertical divergence (approx. 5° FWHM) in transmitted light. Each lenticular element was separated by a narrow ridge of approximately 5 μm in width. This microstructure was replicated from the original master shape using a photopolymer replication process, wherein a liquid photopolymer (Sartomer PRO6500) was flowed between the original master and a blank 3 mil polyester sheet using a laminator, then cured using UV light at approximately 300 W/inch centered around 360 nm in wavelength, followed by separation of the original master.

The microstructure thus produced was coated with a coating mixture comprising three parts by weight Starbrite 4102EAC metallized flake pigment (Silberline) and five parts by weight clear gloss polyurethane (Minwax). The coating mixture was applied to the microstructure surface using a gravure roll having 55 lines per inch. The coating mixture was cured at room temperature for five hours followed by an additional heat cure under an IR lamp for one minute. The resulting coating was about 25 micrometers in thickness, and had a gray-matte finish.

When configured as a front screen, the sample of Example 2 demonstrated an on-axis gain of 4.8 versus a Lambertian diffuser, a horizontal light divergence of 48° FWHM, a vertical light divergence of 16° FWHM, and total reflectance of 75% compared to a Lambertian reflector. For comparison, a typical Lambertian screen may produce a gain of 1.0, a horizontal divergence of 120° FWHM and a vertical divergence of 120° FWHM. Thus, the screen produced according to this example showed much higher on-axis brightness compared to a typical Lambertian screen, with a smaller horizontal view angle and a much smaller vertical view angle. The screen sample also demonstrated excellent rejection of ambient light from sources vertically displaced from the screen (e.g. overhead lights). When viewed with a projected image, the screen showed excellent contrast and visibility in a brightly lit setting, and very good color saturation and picture detail, indicative of high contrast compared to a Lambertian type screen. In addition, the screen sample showed good resistance to scratching and smudging, and showed no damage after being tightly rolled into a cylindrical shape, such as might be done for screen storage.

### EXAMPLE 3

This example describes the construction of a front projection screen in accordance with some embodiments of the invention. A microstructure was originated as previously disclosed using shape generation followed by replication on a 7 mil thick polyester sheet. The microstructure of this example consists of a lenticular-like concave shape (similar to that shown in FIG. 2) with a width of about 80 μm and a depth of about 40 μm. The curvature of the lenticular shape was aspherical across the horizontal direction and produced broad horizontal divergence (approximately 70° FWHM) and narrow vertical divergence (approx. 15° FWHM) in transmitted light. Each lenticular element was separated by a narrow ridge of approximately 5 μm in width. This microstructure was replicated from the original master shape using a photopolymer replication process, wherein a liquid photopolymer (Sartomer PRO6500) was flowed between the original master and a blank 7 mil polyester sheet using a laminator, then cured using UV light at approximately 300 W/inch centered around 360 μm in wavelength, followed by separation of the original master.

The microstructure thus produced was coated with a coating mixture comprising one part by weight Starbrite 4102EAC metallized flake pigment (Silberline) and nine parts by weight clear screen ink (Nazdar 9727). The coating mixture was screen-printed onto the surface of the microstructure using a 12XX printing screen and a 75-durometer polyurethane squeegee, with the screen off-contact by 1/16″. The coating was dried for one hour at room temperature followed by heating to 120° C for ten minutes. The resulting coating was about 25 micrometers in thickness, and had a gray-matte finish.

When configured as a front screen, the sample of Example 3 demonstrated an on-axis gain of 1.5 versus a Lambertian diffuser, a horizontal light divergence of 110° FWHM, a vertical light divergence of 34° FWHM, and total reflectance of 79% compared to a Lambertian reflector. For comparison, a typical Lambertian screen may produce a gain of 1.0, a horizontal divergence of 120° FWHM and a vertical divergence of 120° FWHM. Thus, the screen produced according to this example showed higher on-axis brightness compared to a typical Lambertian screen, with a similar horizontal view angle and a smaller vertical view angle. The screen sample also demonstrated excellent rejection of ambient light from sources vertically displaced from the screen (e.g. overhead lights). When viewed with a projected image, the screen showed excellent contrast and visibility in a brightly lit setting, and very good color saturation and picture detail, indicative of high contrast compared to a Lambertian type screen. In addition, the screen sample showed good resistance to scratching and smudging, and showed no damage after being tightly rolled into a cylindrical shape, such as might be done for screen storage.

In the drawings and specification, there have been disclosed embodiments of the invention and, although specific terms are employed, they are used in a generic and descriptive sense only and not for purposes of limitation. The following claims are provided to ensure that the present application meets all statutory requirements as a priority application in all jurisdictions and shall not be construed as setting forth the scope of the present invention.

What is claimed:

1. A front projection screen comprising:
a microstructure on an upper surface of a substrate, the microstructure including a surface that is inclined relative to the upper surface; and
a conformal reflective layer, conforming to the surface of the microstructure, including discrete reflective microscopic objects, a respective one of which is substantially aligned to a respective opposing portion of the inclined surface of the microstructure.

2. A screen according to claim 1 wherein the surface of the microstructure is a curved or planar surface.

3. A screen according to claim 2 wherein the curved surface comprises a first curved surface curved in a first dimension of the microstructure, wherein the microstructure further comprises:
a second surface in a second dimension of the microstructure.

4. A screen according to claim 3 wherein the second surface comprises a curved or a planar surface.

5. A screen according to claim 3 wherein the first curved surface comprises a first convex shaped surface that is curved in the first dimension; and
wherein the second surface comprises a second convex shaped surface that is curved in the second dimension, wherein the first and second dimensions are substantially orthogonal to one another.

6. A screen according to claim 2 wherein the curved surface comprises a concave shaped surface that is curved in a first dimension to provide a recess having an opening that is about 80 microns wide and about 40 microns deep and that extends in a second dimension, substantially orthogonal to the first dimension, to provide a lenticular shape for the curved surface.

7. A screen according to claim 2 wherein a major dimension of the respective one of the discrete reflective microscopic objects is substantially aligned to the curved surface.

8. A screen according to claim 7 wherein the major dimension of the discrete reflective microscopic objects measures about 1 micron to about 20 microns.

9. A screen according to claim 7 wherein the major dimension of the discrete reflective microscopic objects is substantially parallel to opposing portions of the curved surface.

10. A screen according to claim 2 wherein the discrete reflective microscopic objects are self-aligned to respective opposing portions of the curved or planar surface.

11. A screen according to claim 2 wherein some of the discrete reflective microscopic objects overlap one another.

12. A screen according to claim 2 wherein the discrete reflective microscopic objects comprise a reflective material.

13. A screen according to claim 2 wherein the discrete reflective microscopic objects comprise reflective pigment or a reflective ink.

14. A screen according to claim 13 wherein the reflective pigment comprises aluminum pigment.

15. A screen according to claim 14 wherein the aluminum pigment comprises ATA 737 aluminum leafing pigment.

16. A screen according to claim 1 wherein the substrate has a thickness of about 3 mm to about 7 mm.

17. A method of forming a front projection screen comprising:
forming a conformal reflective layer on an inclined surface of a microstructure, including discrete reflective microscopic objects, a respective one of which is substantially self-aligned to an opposing portion of the inclined surface of the microstructure.

18. A method according to claim 17 wherein the inclined surface of the microstructure is inclined relative to an upper surface of a substrate on which the microstructure in located.

19. A method according to claim 17 wherein forming a conformal reflective layer comprises:
applying a liquid or a powder including the discrete reflective microscopic objects on the surface of the microstructure; and
curing the liquid or powder to provide the conformal reflective layer.

20. A method according to claim 19 wherein the inclined surface of the microstructure comprises a curved surface.

21. A method according to claim 19 wherein the microscopic objects comprise ferromagnetic or dielectric objects, the method further comprising:
applying an electric or magnetic force to the liquid or powder prior to curing.

22. A method according to claim 17 wherein the inclined surface of a microstructure comprises a convex or concave shaped surface.

23. A method according to claim 20 wherein major dimensions of the discrete reflective microscopic objects are substantially parallel to respective opposing portions of the non-planar surface.

24. A method according to claim 20 wherein the discrete reflective microscopic objects are formed self-aligned to respective opposing portions of the curved surface.

25. A method according to claim 20 wherein some of the discrete reflective microscopic objects overlap one another.

26. A method according to claim 20 wherein the discrete reflective microscopic objects comprise aluminum pigment.

27. A method according to claim 20 wherein the discrete reflective microscopic objects comprise ATA 737 aluminum leafing pigment.

28. A method according to claim 17 further comprising:
forming the microstructure on a substrate having an initial thickness of about 3 mm to about 7 mm.

29. A method of forming a front projection screen comprising:
forming a plurality of lenticular concave microstructures having asperical shapes with openings of about 80 microns and depths of about 40 microns;
applying, to the plurality of lenticular concave microstructures, a liquid mixture including aluminum flake pigment having an average particle size of about 14 microns; and
heating the plurality of lenticular concave microstructures having the liquid applied thereto at a temperature of about 200° F.

30. A method according to claim 29 wherein applying, to the plurality of lenticular concave microstructures, a liquid mixture comprises:
spreading the liquid over the microstructures in a direction parallel to a direction in which ridges between the microstructures extend.

31. A method according to claim 29 wherein forming a plurality of lenticular concave microstructures comprises forming the plurality of lenticular concave microstructures in a polyester sheet having an initial thickness of about 7 mm.

32. A method according to claim 29 wherein the aluminum flake pigment comprises ATA 737 aluminum leafing pigment.

33. A method according to claim 32 wherein the liquid mixture further comprises:
2 parts by weight air-cure polyurethane resin in a solvent, 1 part by weight of the aluminum flake pigment, and 1 part by weight organic solvent.

34. A method of forming a front projection screen comprising:
forming a plurality of lenticular concave microstructures having asperical shapes with openings of about 80 microns and depths of about 40 microns, separated from one another by 5 micron wide planar ridges;
applying, to the plurality of lenticular concave microstructures, a liquid mixture including metalized flake pigment; and
curing the plurality of lenticular concave microstructures having the liquid applied thereto at about 60° F. to about 75° F. for about five hours.

35. A method according to claim 34 wherein applying, to the plurality of lenticular concave microstructures, a liquid mixture comprises:
applying the liquid mixture using a gavure roll having about 55 lines per inch.

36. A method of forming a front projection screen comprising:
forming a plurality of lenticular concave microstructures having asperical shapes with openings of about 80 microns and depths of about 40 microns;
applying, to the plurality of lenticular concave microstructures, a liquid mixture including metalized flake pigment; and
curing the plurality of lenticular concave microstructures having the liquid applied thereto at about 60 to about 75° F. for about one hour and then heating to about 120° F. for about 10 minutes.

37. A method according to claim 36 wherein applying, to the plurality of lenticular concave microstructures, a liquid mixture comprises:
screen printing the microstructures with the liquid mixture and drawing a squeegee across the microstructures while maintaining a separation of about one-sixteenth of an inch between the squeegee and the microstructures.

38. A microstructure template comprising:
a microstructure on an upper surface of a substrate, the microstructure including a surface that is inclined relative to the upper surface; and
a conformal reflective layer, conforming to the surface of the microstructure, including discrete reflective microscopic objects substantially aligned to respective opposing portions of the inclined surface of the microstructure.
